(19) United States
(12) Patent Application Publication
(10) Pub. No.: US 2026/0182606 A1
(43) Pub. Date: Jul. 2, 2026

(54) KUDZU ROOT FERMENT AND PRODUCTION METHOD THEREOF

(71) Applicant: Jingchu University of Technology, Jingmen City (CN)

(72) Inventors: Jinsong Wang, Jingmen City (CN); Deyan Zhu, Jingmen City (CN); Rong Li, Jingmen City (CN); Yijiao Sun, Jingmen City (CN); Tianyao Zhao, Jingmen City (CN); Yechuan Huang, Jingmen City (CN); Zhuqing Zheng, Jingmen City (CN); Qingchan Chen, Jingmen City (CN)

(21) Appl. No.: 19/329,614

(22) Filed: Sep. 16, 2025

(30) Foreign Application Priority Data
Dec. 31, 2024 (CN) 2024119942075

(51) Int. Cl. A23L 2/38; A23L 2/04; A23L 2/56

(52) U.S. Cl. CPC A23L 2/382; A23L 2/04; A23L 2/56

(57) ABSTRACT

The invention discloses kudzu root ferment and the preparation method thereof. The preparation method comprises the following steps: preparing kudzu root into kudzu root juice; adjusting the pH of the kudzu root juice; inoculating with Lactobacillus plantarum Z38 and yellow rice wine yeast; performing ultrasonication and conducting the first fermentation to obtain the primary fermentation broth; adding a carbon source to the primary fermentation broth and adjusting the pH; inoculating again with Lactobacillus plantarum Z38 and yellow rice wine yeast followed by a second fermentation to obtain the secondary fermentation broth; and adding a stabilizer and a flavoring agent to the secondary fermentation broth and adjusting the pH. The method of the present invention significantly enhancing the acetaldehyde dehydrogenase activity, pueraria flavonoids content, physicochemical components, and amino acid levels in the kudzu root ferment. This process improves the nutritional value, flavor profile, and alcohol-sobriety capacity of the kudzu root ferment.

### FIELD OF THE DISCLOSURE

The present disclosure relates to a kudzu root ferment and a method for producing the same.

### BACKGROUND

Kudzu (Pueraria montana var. lobata) root is rich in nutrients such as starch, isoflavones, organic acids, polysaccharides, saponins, and essential amino acids. Among these, pueraria polysaccharides exhibit various physiological functions, including antioxidant activity, immune regulation, lipid- and glucose-lowering effects, as well as alcohol detoxification and liver protection. Puerarin exhibits anti-inflammatory and anti-cancer properties, while ethanol extracts of kudzu root demonstrate strong hydroxyl radical-scavenging ability. Additionally, pueraria flavonoids and puerarin can alleviate alcohol-induced hepatic steatosis. Therefore, using kudzu root as a raw material for producing ferment holds significant health-promoting potential. Edible plant ferment is a human-consumable product containing specific bioactive components, produced through microbial fermentation of food-grade plant materials with or without supplementary ingredients. The edible plant ferment is rich in various nutrients and bioactive substances such as polyphenols, vitamins, minerals, amino acids, and organic acids. It possesses functional benefits including antioxidant effects, digestive system support, and immune system enhancement. The kudzu root ferment exhibits certain anti-alcohol effects, primarily because some kudzu root ferments contain aldehyde dehydrogenase (ALDH). Aldehyde dehydrogenase plays a key role in the metabolic breakdown of alcohol, converting it into carbon dioxide and water, which are then expelled from the body.

However, in kudzu root ferment prepared using existing techniques, the aldehyde dehydrogenase content is low, the enzymatic activity is weak, and the variety and concentration of other physicochemical components are limited. As a result, the anti-alcohol efficacy of kudzu root ferment is suboptimal, compounded by their poor stability and undesirable taste.

Therefore, there is a need for a technical solution to enhance both the anti-alcohol efficacy and stability of kudzu root ferment.

### SUMMARY

The present disclosure provides a kudzu root ferment and a production method thereof, aiming to address the challenge of enhancing both the anti-alcohol efficacy and stability of kudzu root ferment.

The purpose of the invention is realized through the following technical solutions:

In the first aspect, the present invention provides a production method for kudzu root ferment, comprising the following steps:
(1) using kudzu root as raw material, sequentially performing crushing, pulping, homogenization, centrifugation, and steaming to obtain kudzu root juice;
(2) adjusting the pH of the kudzu root juice, and then adding Lactobacillus plantarum Z38 and yellow rice wine yeast, followed by ultrasonication and primary fermentation to obtain primary fermentation broth;
(3) adding a carbon source to the primary fermentation broth, adjusting pH, then adding Lactobacillus plantarum Z38 and yellow rice wine yeast again, followed by secondary fermentation to obtain secondary fermentation broth;
(4) adding stabilizers and flavoring agents to the secondary fermentation broth, adjusting pH, thereby obtaining the kudzu root ferment.

Preferably, the specific operations of step (1) are sequentially performed as follows: selecting kudzu root cubes, crushing, sieving, adding water, pulping, filtering, homogenizing, centrifuging, steaming, and finally preparing kudzu root juice.

Preferably, in step (1), the kudzu root powder obtained after crushing and sieving is uniformly mixed with distilled water at a solid-to-liquid ratio of 1:15 (g/mL), followed by centrifugation to collect the supernatant; and the supernatant is then steamed for 2 hours and cooled to room temperature to obtain the kudzu root juice.

Preferably, in step (2), the primary fermentation is conducted for 1-7 days at a temperature maintained between 28-36° C.

Preferably, in step (2), the ultrasonication is performed for 30-120 minutes at a frequency ranging from 20 KHz to 50 KHz.

Preferably, in step (2), the pH of the kudzu root juice is adjusted to 4.5-6.5.

Preferably, in step (2) and step (3), the total inoculation amount of Lactobacillus plantarum Z38 and yellow rice wine yeast is 3% (w/w); the ratio of Lactobacillus plantarum Z38 to yellow rice wine yeast ranges from (1-3):(1-3); and Lactobacillus plantarum Z38 was deposited with the China Center for Type Culture Collection (CCTCC) on Oct. 31, 2024, under accession number CCTCC M 20242392.

The strain Lactobacillus plantarum Z38 exhibits DPPH radical-scavenging activity, bile salt hydrolase (BSH) activity, reducing activity, and hydroxyl radical (OH) scavenging activity, along with tolerance to gastric juice and resistance to intestinal fluid.

The strain Lactobacillus plantarum Z38 is capable of producing aldehyde dehydrogenase, with an enzymatic yield≥135.54 U/mL under optimal conditions.

Preferably, in step (3), the carbon source is selected from brown sugar and lemon slices.

Preferably, in step (3), the pH is adjusted to 4.5-5.5.

Preferably, in step (4), the stabilizer is selected from the group consisting of xanthan gum, sodium alginate, pectin, and combinations thereof; and the flavoring agent includes, but is not limited to, white sugar.

Preferably, in step (4), the pH is adjusted to 4.0-5.0.

In the second aspect, the invention provides a kudzu root ferment prepared by the production method according to the invention.

The advantages of the technical scheme proposed in the disclosure are:

Compared with conventional single fermentation, the present invention significantly enhances both aldehyde dehydrogenase activity and physicochemical composition of kudzu root ferment through a dual fermentation process (primary+secondary fermentation). The kudzu root ferment prepared by the present invention exhibits superior alcohol-detoxifying efficacy and is enriched with multiple essential amino acids, offering enhanced nutritional value and improved flavor profile. The present invention utilizes a mixed microbial consortium of yellow rice wine yeast and Lactobacillus plantarum Z38 for dual fermentation of kudzu root, producing a novel functional beverage with alcohol-detoxifying properties. This innovation significantly enhances the comprehensive utilization of kudzu root as a medicinal and edible homologous resource.

### BRIEF DESCRIPTION OF THE DRAWINGS

FIG. 1 illustrates the effect of fermentation time on aldehyde dehydrogenase activity in the primary fermentation broth.

FIG. 2 illustrates the effect of fermentation temperature on aldehyde dehydrogenase activity in the primary fermentation broth.

FIG. 3 illustrates the effect of initial pH on aldehyde dehydrogenase activity in the primary fermentation broth.

FIG. 4 illustrates the effect of microbial ratio (Lactobacillus plantarum Z38: yellow rice wine yeast) on aldehyde dehydrogenase activity in the primary fermentation broth.

FIG. 5 illustrates the effect of ultrasonication duration on aldehyde dehydrogenase activity in the primary fermentation broth.

FIG. 6 illustrates the effect of ultrasonication intensity on aldehyde dehydrogenase activity in the primary fermentation broth.

FIG. 7 illustrates the pueraria flavonoids concentration changes during fermentation.

FIG. 8 illustrates the effects of different stabilizers on the stability of kudzu root ferment.

### DETAILED DESCRIPTION OF PREFERRED EMBODIMENTS

The invention will be further described in detail in combination with embodiments to make the purpose, technical scheme, and advantages of the invention clear. The specific embodiments described herein are only used to explain the invention and are not intended to limit the invention.

The method for obtaining the strain Lactobacillus plantarum Z38 comprises the following steps:

Transfer the fermentation broth from Northeast Chinese kimchi during its vigorous fermentation period to centrifuge tube 1, centrifuge at 10,000 rpm for 1 minute, and discard the supernatant. Add physiological saline to the precipitate, mix well, and centrifuge again, discarding the supernatant.

Transfer physiological saline into the tube 1, mix thoroughly to obtain a bacterial suspension diluted to 10⁻¹. Add 900 μL of physiological saline each to centrifuge tubes 2-4, then transfer 100 μL of the bacterial suspension from tube 1 to tube 2 and mix to achieve a 10⁻² dilution. Repeat this process sequentially to dilute tube 3 to 10⁻³ and tube 4 to 10⁻⁴. Take 0.2 mL of the diluted solution from tubes 1-4, inoculate onto lactic acid bacteria isolation medium using the spread plate method, and incubate at 37° C. for 48 hours in a constant temperature and humidity incubator. After colony formation, observe their morphology, select colonies surrounded by discoloration halos, and perform repeated streak plate isolation to obtain purified single colonies. The isolated Lactobacillus plantarum Z38 strain was preserved on agar slants for culture maintenance.

The morphological characteristics of Lactobacillus plantarum Z38 include: light green colonies with irregular margins, viscous surface texture, and small to medium-sized colony formation.

The following performance tests were conducted on Lactobacillus plantarum Z38:

1. Nucleotide sequence analysis: the rDNA-ITS2 sequence of Lactobacillus plantarum Z38 was obtained through sequencing and showed 99% similarity with the rDNA-ITS2 sequences of Lactobacillus strains in the GenBank database via NCBI BLAST alignment analysis.

2. The biological activities of Lactobacillus plantarum Z38 are presented in table 1.

TABLE 1

| Biological activities | Lactobacillus plantarum Z38 |
|---|---|
| DPPH radical-scavenging activity | 39.46% |
| BSH activity | 0.114 |
| Reducing activity | 320.75 |
| Hydroxyl radical (•OH) scavenging | 73.68% |
| activity | |

3. Growth characteristics: Lactobacillus plantarum Z38 exhibited slow growth during the initial 4 hours of cultivation, entered the logarithmic growth phase at approximately 6 hours, and reached maximum OD_{600 nm} of 1.591 at 18 hours, after which it transitioned into the stationary phase.

4. Gastric acid tolerance tests. A 0.2 mL bacterial suspension (10⁸ CFU/mL) was inoculated into 1.0 mL of filter-sterilized (0.22 μm) artificial gastric juice (pH 2.0) and 0.3 mL NaCl. After thorough mixing, samples were incubated at 37° C. for 1 minute, 90 minutes, and 180 minutes, followed by serial dilution (10⁻¹⁰) and standard plate counting. All tests were performed in triplicate, and the mean values were calculated as presented in table 2.

TABLE 2

| | Viable count Log10 (CFU/mL) | | | |
|---|---|---|---|---|
| | Control | 1 | | |
| Strain | (0 h) | min | 90 min | 180 min |
| Lactobacillus plantarum | >300 | >300 | 176.00 ± 4.00 | 41.33 ± 1.53 |
| Z38 | | | | |

5. Intestinal fluid tolerance tests. A 0.2 mL bacterial suspension (10⁸ CFU/mL) was inoculated into 1.0 mL of filter-sterilized (0.22 μm) artificial intestinal fluid (pH 8.0) and 0.3 mL NaCl. After thorough mixing, samples were incubated at 37° C. for 1 minute and 240 minutes, followed by serial dilution (10⁻¹⁰) and standard plate counting. All tests were performed in triplicate, and the mean values were calculated as presented in table 3.

TABLE 3

Viable count Log10 (CFU/mL)

| Strain | Control (0 h) | 1 min | 240 min |
|---|---|---|---|
| Lactobacillus plantarum | >300 | >300 | 36.33 ± 2.08 |
| Z38 | | | |

6. Enzyme production capacity test. The bacterial seed solution was inoculated into the medium at a 5% inoculation rate and incubated at a constant temperature of 37° C. for 18 hours. The resulting fermentation broth was centrifuged at 5000 rpm and 4° C., and the precipitate was washed twice with sterile saline. The bacterial sludge was collected and resuspended in phosphate buffer at a ratio of 1:4.5 (v/v) to prepare a bacterial suspension. The suspension was subjected to ultrasonic disruption at 100 W for 20 minutes in an ice bath, followed by centrifugation at 5000 rpm and 4° C. to collect the supernatant. The precipitate was treated in the same manner, and the two supernatants were combined to obtain the crude enzyme solution. The activity of aldehyde dehydrogenase in the crude enzyme solution was measured, and the test results for different bacteria are shown in table 4.

TABLE 4

| | Activity of aldehyde dehydrogenase |
|---|---|
| Strain | (U/mL) |
| Lactobacillus plantarum Z38 | 135.54 |
| Ordinary Lactobacillus plantarum | 32.24 |
| Escherichia coli | 4.56 |

### Example 1

This embodiment provides a production method for kudzu root ferment, comprising the following steps:

(1) Kudzu root cubes are crushed and sieved to obtain kudzu powder. The powder is mixed with distilled water at a solid-to-liquid ratio of 1:15 (g/mL), homogenized, and then centrifuged to collect the supernatant. The supernatant is steamed for 2 hours and cooled to room temperature to obtain kudzu root juice.

(2) The pH of the kudzu root juice is adjusted to 4.5 (initial pH). Then, Lactobacillus plantarum Z38 and yellow rice wine yeast are added at a total inoculation amount of 3%, with a ratio of 1:2 (strain Z38: yeast). The mixture is sonicated at 60% intensity for 60 minutes, followed by primary fermentation at 34° C. for 6 days to obtain the primary fermentation broth.

(3) To the primary fermentation broth, 15 wt % brown sugar and 9 wt % lemon slices are added, and the pH is readjusted to 4.5. Lactobacillus plantarum Z38 and yellow rice wine yeast are reintroduced at a total of 3% (1:2 ratio). Secondary fermentation is then conducted at 32° C. for 6 days, producing the secondary fermentation broth.

(4) The secondary fermentation broth is supplemented with 0.05 wt % sodium alginate and 6 wt % white sugar, and its pH is adjusted to 5.0 using sodium bicarbonate, resulting in the final kudzu root ferment product.

### Example 2-8

These embodiments each provide a distinct production method for kudzu root ferment. Unlike example 1, in step (2) of examples 2-8, the fermentation temperature was maintained at 32° C., while the fermentation duration was sequentially varied to 1, 2, 3, 4, 5, 6, and 7 days, respectively. All other parameters were consistent with example 1.

### Example 9-12

These embodiments each provide a distinct production method for kudzu root ferment. Unlike example 1, in step (2) of examples 9-12, the fermentation temperature was set at 28° C., 30° C., 32° C., and 36° C. respectively. All other parameters were consistent with example 1.

### Example 13-17

These embodiments each provide a distinct production method for kudzu root ferment. Unlike example 1, in step (2) of examples 13-17, the initial pH was set to 4.5, 5.0, 5.5, 6.0, and 6.5 respectively, and the ultrasonication time was uniformly 30 minutes for all cases. All other parameters were consistent with example 1.

### Example 18-22

These embodiments each provide a distinct production method for kudzu root ferment. Unlike example 1, in step (2) of examples 18-22, the ultrasonication time was 30 minutes for all cases, but the ratios of Lactobacillus plantarum Z38 to yellow rice wine yeast were 1:1, 1:2, 1:3, 2:1, and 3:1, respectively. All other parameters were consistent with example 1.

### Example 23-26

These embodiments each provide a distinct production method for kudzu root ferment. Unlike example 1, in step (2) of examples 23-26, the ultrasonication times were 0 min, 30 min, 90 min, and 120 min, respectively. All other parameters were consistent with example 1.

### Example 27-30

These embodiments each provide a distinct production method for kudzu root ferment. Unlike example 1, in step (2) of examples 27-30, based on a rated power of 50 kHz, the ultrasonication intensities were set at 0%, 60%, 90%, and 120% respectively. All other parameters were consistent with example 1.

### Example 31-39

These embodiments each provide a distinct production method for kudzu root ferment. Unlike example 1, in step (2) of examples 31-39, the initial pH, ultrasonication time, and ultrasonication intensity were set according to the conditions specified in table 5. All other parameters were consistent with example 1.

TABLE 5

| | | Ultrasonication | Ultrasonication |
|---|---|---|---|
| Example | Initial pH | time (min) | intensity (%) |
| Example31 | 4.5 | 30 | 30 |
| Example32 | 4.5 | 60 | 60 |
| Example33 | 4.5 | 90 | 90 |
| Example34 | 5.0 | 30 | 60 |
| Example35 | 5.0 | 60 | 90 |
| Example36 | 5.0 | 90 | 30 |
| Example37 | 5.5 | 30 | 90 |
| Example38 | 5.5 | 60 | 30 |
| Example39 | 5.5 | 90 | 60 |

### Example 40-48

These embodiments each provide a distinct production method for kudzu root ferment. Unlike example 1, in step (3) of examples 40-48, the process conditions for the second fermentation were set according to table 6. All other parameters were consistent with example 1.

TABLE 6

| | Brown sugar | Lemon slices | | Fermentation |
|---|---|---|---|---|
| Example | (wt %) | (wt %) | pH | temperature(° C.) |
| Example40 | 5 | 3 | 4.0 | 32 |
| Example41 | 5 | 6 | 4.5 | 34 |
| Example42 | 5 | 9 | 5.0 | 36 |
| Example43 | 10 | 3 | 4.5 | 36 |
| Example44 | 10 | 6 | 5.0 | 32 |
| Example45 | 10 | 9 | 4.0 | 34 |
| Example46 | 15 | 3 | 5.0 | 34 |
| Example47 | 15 | 6 | 4.0 | 36 |
| Example48 | 15 | 9 | 4.5 | 32 |

### Example 49-63

These embodiments each provide a distinct production method for kudzu root ferment. Unlike example 1, in step (4) of examples 49-63, the sodium alginate was sequentially replaced with: 0 wt % xanthan gum, 0.05 wt % xanthan gum, 0.1 wt % xanthan gum, 0.15 wt % xanthan gum, 0.2 wt % xanthan gum, 0 wt % sodium alginate, 0.05 wt % sodium alginate, 0.1 wt % sodium alginate, 0.2 wt % sodium alginate, 0 wt % pectin, 0.05 wt % pectin, 0.1 wt % pectin, 0.15 wt % pectin, and 0.2 wt % pectin. All other parameters were consistent with example 1.

### Example 64-72

These embodiments each provide a distinct production method for kudzu root ferment. Unlike example 1, in step (4) of examples 64-72, the addition amounts of white sugar and stabilizer, as well as the pH value, were set according to the parameters specified in table 7. All other parameters were consistent with example 1.

TABLE 7

| Example | White sugar (wt %) | pH | Stabilizer (wt %) |
|---|---|---|---|
| Example64 | 2 | 4.0 | 0.03 |
| Example65 | 2 | 4.5 | 0.05 |
| Example66 | 2 | 5.0 | 0.07 |
| Example67 | 4 | 4.0 | 0.05 |
| Example68 | 4 | 5.5 | 0.07 |
| Example69 | 4 | 5.0 | 0.03 |
| Example70 | 6 | 4.0 | 0.07 |
| Example71 | 6 | 4.5 | 0.03 |
| Example72 | 6 | 5.0 | 0.05 |

Physicochemical indices testing: samples from different fermentation stages (i.e., kudzu root juice, primary fermentation broth, and secondary fermentation broth) were collected for analysis, with all following indicators measured in triplicate.

(1) Determination of pueraria flavonoids concentration. A standard rutin calibration curve was established by plotting rutin concentration (x) versus absorbance (y), yielding the regression equation y=21.601x+0.0256 (R²=0.9985). Using 30% ethanol solution as blank control, the absorbance was measured at 500 nm following UV-Vis spectrophotometric methodology. The pueraria flavonoids concentration in each sample was subsequently calculated based on the rutin standard curve regression equation.

(2) Determination of pH. The measurement was performed in accordance with the Chinese National Standard GB 5009.237-2016 “Determination of pH in Foods”.

(3) Determination of reducing sugar content. The analysis was conducted according to the Chinese National Standard GB 5009.7-2016 “Determination of Reducing Sugar in Foods”.

(4) Determination of total acid. The analysis was conducted according to the Chinese National Standard GB 12456-2021 “Determination of Total Acid in Foods”.

(5) Determination of ethanol content. The analysis was carried out according to the Chinese National Standard GB/T 12143-2018 “Determination of Ethanol in Food Products”.

(6) Determination of Lactic Acid Bacteria content. The analysis was conducted according to the Chinese National Standard GB 4789.35-2016 “Food Microbiological Examination—Examination of Lactic Acid Bacteria”.

(7) Determination of vitamin content. The analysis was conducted according to the Chinese National Standards GB 5009.85-2016 “Determination of Vitamin B₂ in Foods” and GB 5009.154-2023 “Determination of Vitamin B₆ in Foods” for quantifying vitamins B₂ and B₆.

(8) Determination of amino acids. The analysis was conducted according to the Chinese National Standard GB 5009.124-2016 “Determination of Amino Acids in Foods” to identify and quantify amino acid species and their concentrations.

(9) Determination of aldehyde dehydrogenase activity. Add 2.52 mL of Tris-HCl buffer (0.05 mol/L, pH 8.0), 0.1 mL of EDTA solution (0.05 mol/L), 0.1 mL of potassium chloride solution (3 mol/L), 0.1 mL of NAD+ solution (0.02 mol/L), 0.05 mL of acetaldehyde solution (0.1 mol/L), and 0.03 mL of β-mercaptoethanol solution (0.05 mol/L) into a cuvette. After thorough mixing, add 0.1 mL of the test sample, mix quickly, and measure the absorbance at 340 nm. Calculate the change in absorbance (ΔA340) over 5 minutes.

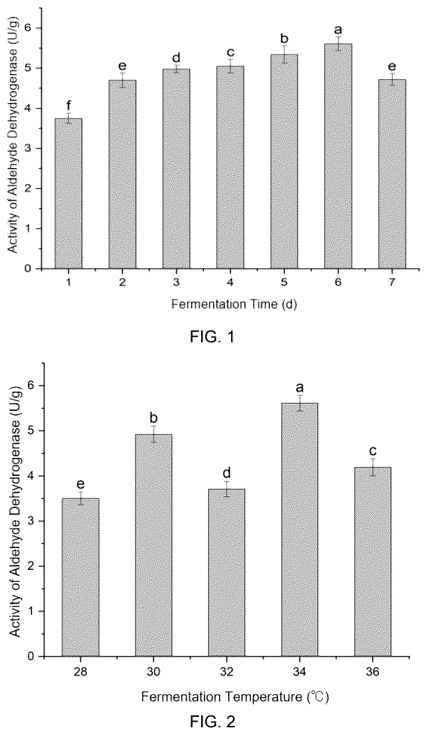

FIG. 1 illustrates the effect of fermentation time on aldehyde dehydrogenase activity in the primary fermentation broth. When the fermentation time was 1 day, the aldehyde dehydrogenase activity produced in the fermentation broth was relatively low. At 6 days of fermentation, the enzyme activity reached its peak level. The aldehyde dehydrogenase activity in the fermentation broth showed a steady increase with prolonged fermentation time. Insufficient fermentation duration significantly impaired broth processing, preventing it from reaching conditions conducive to microbial cell growth. This demonstrates that appropriate fermentation time positively influences microbial proliferation and benefits kudzu root fermentative processes. However, prolonged fermentation leads to decreased nutrient availability. Therefore, the optimal fermentation time for kudzu root fermentation broth was determined to be 6 days.

FIG. 2 illustrates the effect of fermentation temperature on aldehyde dehydrogenase activity in the primary fermentation broth. The activity of aldehyde dehydrogenase in the fermentation broth was relatively low at 28° C. When the temperature increased to 34° C., the aldehyde dehydrogenase activity reached its peak level, but showed a decline with further temperature elevation. The appropriate fermentation temperature significantly promoted metabolic activities of both yeast and lactic acid bacteria, leading to enhanced enzymatic reactions and consequently higher aldehyde dehydrogenase production. Both excessively high and low temperatures were found to adversely affect microbial metabolism and impair enzymatic processes. Therefore, 34° C. was determined to be the optimal fermentation temperature.

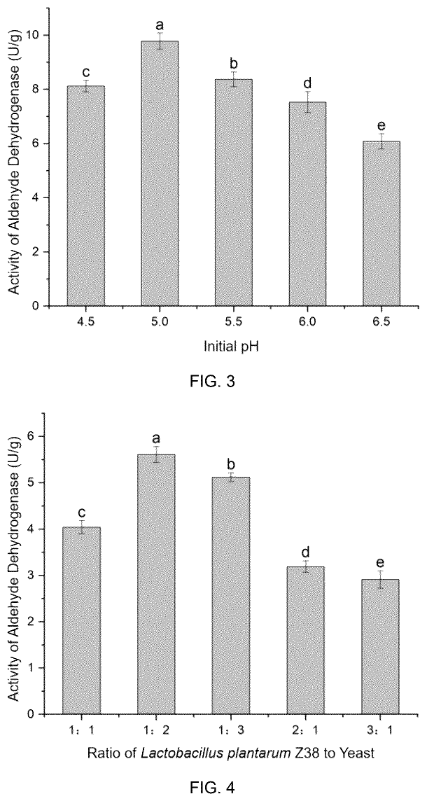

FIG. 3 illustrates the effect of initial pH on aldehyde dehydrogenase activity in the primary fermentation broth. The aldehyde dehydrogenase activity remained at a relatively low level at pH 6.5, but reached its maximum at pH 5.0, followed by a gradual decrease with further pH elevation. An appropriate pH significantly promoted the growth of both yeast and lactic acid bacteria, thereby enhancing aldehyde dehydrogenase production. However, continuous acid production by lactic acid bacteria during fermentation may lead to excessive acidification, which could subsequently inhibit microbial growth and aldehyde dehydrogenase synthesis, ultimately reducing aldehyde dehydrogenase content in the fermentation broth. Therefore, the optimal initial pH was determined to be 5.0.

FIG. 4 illustrates the effect of microbial ratio (Lactobacillus plantarum Z38: yellow rice wine yeast) on aldehyde dehydrogenase activity in the primary fermentation broth. The aldehyde dehydrogenase activity in the fermentation broth was relatively low at a 3:1 ratio. Maximum aldehyde dehydrogenase production was achieved at a 1:2 ratio, beyond which enzymatic activity gradually decreased with increasing microbial ratios. Higher microbial ratios may alter the broth's osmotic pressure, creating unfavorable conditions for metabolite accumulation and consequently impairing aldehyde dehydrogenase biosynthesis. Therefore, the optimal ratio between Lactobacillus plantarum Z38 and yellow rice wine yeast was determined to be 1:2.

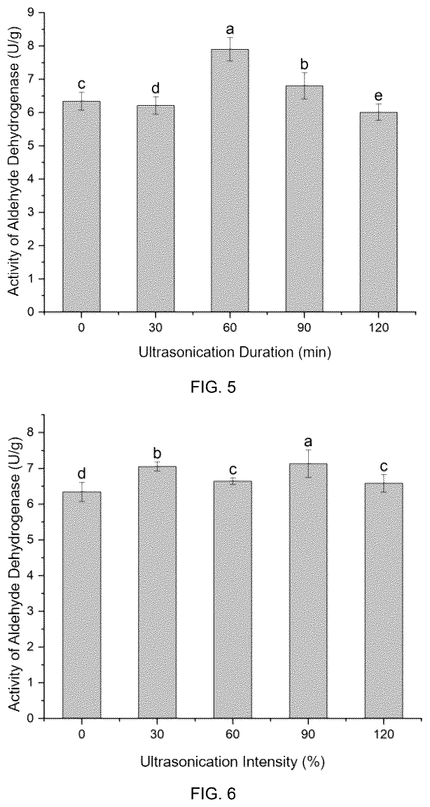

FIG. 5 illustrates the effect of ultrasonication duration on aldehyde dehydrogenase activity in the primary fermentation broth. The aldehyde dehydrogenase activity in the primary fermentation broth showed significantly lower levels at 120 minutes of ultrasonication, while reaching peak enzymatic activity at 60 minutes. Both excessive and insufficient ultrasonication times were found to adversely affect the metabolic processes of Lactobacillus plantarum Z38 and yellow rice wine yeast, leading to impaired enzymatic reactions that restricted metabolite release and accumulation. Therefore, the optimal ultrasonication time is 60 minutes.

FIG. 6 illustrates the effect of ultrasonication intensity on aldehyde dehydrogenase activity in the primary fermentation broth. The aldehyde dehydrogenase activity in the primary fermentation broth remained relatively low without ultrasonication (0% intensity). The enzymatic activity peaked at 90% ultrasonication intensity, followed by a noticeable decline at 120% intensity. This pattern suggests that excessive ultrasonication intensity may induce structural damage to cellular membranes of both yeast and Lactobacillus plantarum Z38, ultimately impairing microbial growth and metabolic functions. Consequently, 90% ultrasonication intensity was identified as the optimal condition.

Table 8 presents the aldehyde dehydrogenase activity levels under different primary fermentation conditions.

TABLE 8

| | | | | Activity of |
|---|---|---|---|---|
| | | | | aldehyde |
| | Initial | Ultrasonication | Ultrasonication | dehydrogenase |
| Example | pH | time (min) | intensity (%) | (U/g) |
| Example31 | 4.5 | 30 | 30 | 5.85 |
| Example32 | 4.5 | 60 | 60 | 6.59 |
| Example33 | 4.5 | 90 | 90 | 6.30 |
| Example34 | 5.0 | 30 | 60 | 5.78 |
| Example35 | 5.0 | 60 | 90 | 6.38 |
| Example36 | 5.0 | 90 | 30 | 6.54 |
| Example37 | 5.5 | 30 | 90 | 5.59 |
| Example38 | 5.5 | 60 | 30 | 6.39 |
| Example39 | 5.5 | 90 | 60 | 6.46 |

As shown in table 8, the optimal primary fermentation conditions for maximizing aldehyde dehydrogenase activity were determined to be: initial pH of 4.5, ultrasonication time of 60 min, and ultrasonication intensity of 60%.

Table 9 presents the aldehyde dehydrogenase activity levels under different secondary fermentation conditions.

TABLE 9

| | | | | | Activity of |
|---|---|---|---|---|---|
| | Brown | Lemon | | Fermentation | aldehyde |
| | sugar | slices | | temperature | dehydrogenase |
| Example | (wt %) | (wt %) | pH | (° C.) | (U/g) |
| Example40 | 5 | 3 | 4.0 | 32 | 24.47 |
| Example41 | 5 | 6 | 4.5 | 34 | 24.38 |
| Example42 | 5 | 9 | 5.0 | 36 | 21.88 |
| Example43 | 10 | 3 | 4.5 | 36 | 28.95 |
| Example44 | 10 | 6 | 5.0 | 32 | 24.58 |
| Example45 | 10 | 9 | 4.0 | 34 | 26.63 |
| Example46 | 15 | 3 | 5.0 | 34 | 25.90 |
| Example47 | 15 | 6 | 4.0 | 36 | 29.13 |
| Example48 | 15 | 9 | 4.5 | 32 | 31.19 |

As shown in table 9, the secondary fermentation achieved optimal aldehyde dehydrogenase activity under the following conditions: 15 wt % brown sugar, 9 wt % lemon slices, pH 4.5, and fermentation temperature of 32° C.

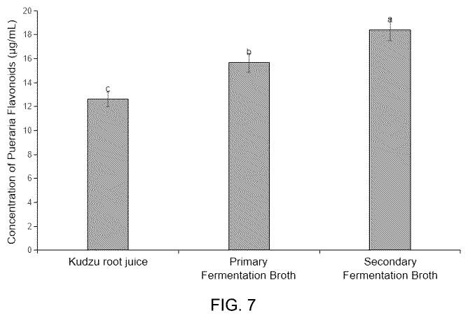

FIG. 7 illustrates the pueraria flavonoids concentration changes during fermentation. The puerarin flavonoid concentration in the primary fermentation broth (15.66 μg/mL) demonstrated a 24.18% increase compared to the kudzu root juice (12.61 μg/mL). A further 17.44% enhancement was observed in the secondary fermentation broth (18.39 μg/mL) relative to the primary stage. This progressive elevation of pueraria flavonoids content across fermentation stages may be attributed to: (1) microbial extracellular enzymes degrading kudzu root cell wall structures, thereby facilitating pueraria flavonoids release; (2) potential microbial synthesis and secretion of additional pueraria flavonoids; and (3) fermentation-derived metabolites (e.g., organic acids) improving pueraria flavonoids stability and solubility in the aqueous phase.

Table 10 presents the physicochemical indices of samples from different fermentation stages.

TABLE 10

| | Kudzu | Primary | Secondary |
|---|---|---|---|
| | root | fermentation | fermentation |
| Physicochemical indices | juice | broth | broth |
| pH | 8.35 ± 0.070 | 5.02 ± 0.105 | 3.91 ± 0.087 |
| Total acid (g/100 mL) | — | 0.01 ± 0.001 | 1.23 ± 0.232 |
| Reducing sugar (g/100 g) | 0.45 ± 0.032 | — | 4.49 ± 0.336 |
| Lactic Acid Bacteria | 2.8 × 10⁵ | 5.9 × 10⁷ | 3.4 × 10⁷ |
| (CFU/mL) | | | |
| Vitamins B₂ (mg/100 g) | — | — | 29.6 ± 0.295 |
| Vitamins B₆ (μg/100 g) | — | — | 260 ± 0.263 |

As shown in table 10, the pH gradually decreases while the total acid content continues to rise, which is attributed to the production of various organic acids by microorganisms during the fermentation process. The reducing sugar content initially decreases and then increases. The reducing sugar content in the primary fermentation broth is zero, as microorganisms consume the carbon sources in the kudzu root juice during fermentation, leading to a reduction in reducing sugar content. During secondary fermentation, brown sugar is added as a carbon source to promote microbial fermentation, resulting in an increase in reducing sugar content in the secondary fermentation broth. The lactic acid bacteria content shows an initial increase followed by a decrease. The reason for this may be that during primary fermentation, the nutrients and oxygen in the fermentation broth are sufficient, allowing Lactobacillus plantarum to proliferate significantly, thereby increasing the lactic acid bacteria content in the primary fermentation broth. Subsequently, during secondary fermentation, the re-inoculation of mixed bacterial strains and the addition of nutrients lead to a reduction in oxygen content in the secondary fermentation broth, causing a decrease in lactic acid bacteria content. Vitamin B₂ and vitamin B₆ are detected only in the secondary fermentation broth. On one hand, this may be due to their production by yeast and Lactobacillus plantarum during secondary fermentation; on the other hand, it may be attributed to the addition of lemon slices and brown sugar during secondary fermentation, which contribute to the generation of vitamins in the secondary fermentation broth.

Table 11 presents the changes in the types of amino acids in the fermentation broth obtained at different fermentation stages.

TABLE 11

| | Kudzu root | Primary | Secondary |
|---|---|---|---|
| | juice | fermentation broth | fermentation broth |
| Amino acid | (g/100 g) | (g/100 g) | (g/100 g) |
| Leucine | — | — | 0.01 ± 0.0026 |
| Isoleucine | — | — | 0.01 ± 0.0019 |
| Lysine | — | — | 0.02 ± 0.0025 |
| Phenylalanine | — | — | 0.01 ± 0.0021 |
| Threonine | — | — | 0.01 ± 0.0024 |
| Valine | — | — | 0.01 ± 0.0031 |
| Histidine | — | — | 0.01 ± 0.0015 |
| Serine | — | — | 0.01 ± 0.0025 |
| Glycine | — | 0.01 ± 0.0028 | 0.01 ± 0.0029 |
| Alanine | — | — | 0.02 ± 0.0022 |
| Aspartic | — | 0.01 ± 0.0032 | 0.06 ± 0.0017 |
| Glutamic | — | 0.01 ± 0.0025 | 0.03 ± 0.0030 |
| Total | — | 0.033 ± 0.0028 | 0.212 ± 0.0024 |

As shown in table 11, microbial fermentation increases the variety and content of amino acids in the fermentation broth. Consequently, the secondary fermentation broth not only possesses nutritional functions and promotes digestion but also develops distinct flavor characteristics. For example, amino acids such as valine and threonine are converted by microorganisms into characteristic flavor compounds, enhancing the overall flavor profile of the secondary fermentation broth.

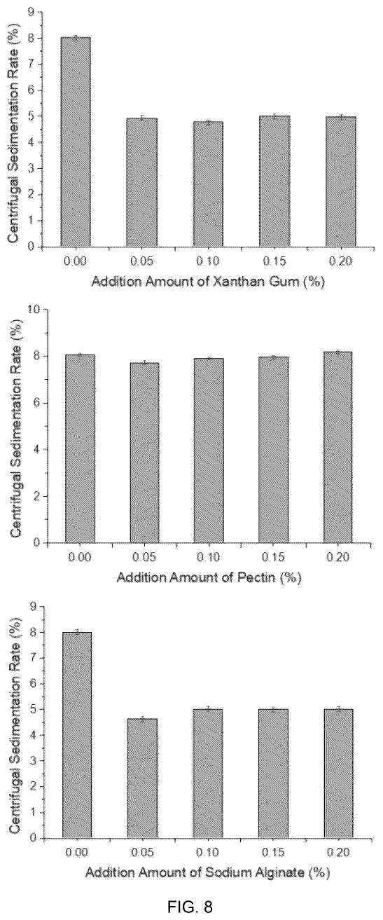

FIG. 8 illustrates the effects of different stabilizers on the stability of kudzu root ferment. FIGS. 8a, 8b, and 8c respectively show the influence of xanthan gum, sodium alginate, and pectin on the stability of kudzu root ferment at varying concentrations. As shown in FIG. 8, both xanthan gum and sodium alginate have a significant impact on the stability of kudzu root ferment, while pectin proves less effective. As the concentration of pectin increases, the centrifugal sedimentation rate of kudzu root ferment first decreases and then increases. When the addition amount reaches 0.15%, the centrifugal sedimentation rate already exceeds the initial level. The lowest centrifugal sedimentation rate occurs at a pectin concentration of 0.05%, though it remains almost comparable to the initial state. Therefore, sodium alginate is preferred as the stabilizer.

The sensory evaluation of kudzu root ferment: ten participants were randomly selected to evaluate nine differently formulated samples based on color, aroma, taste, and texture. The criteria for sensory evaluation of kudzu root ferment are shown in table 12.

TABLE 12

| Evaluation | | Scoring |
|---|---|---|
| Indicators | Sensory evaluation criteria | range |
| Color | brownish-yellow with a pronounced gloss | 16-20 |
| (20 points) | brownish-yellow with a moderately glossy | 11-15 |
| | appearance | |
| | brownish-yellow with a dull luster | 6-10 |
| | brownish-yellow and lusterless | 0-5 |
| Aroma | distinct and elegant kudzu root aroma is | 24-30 |
| (30 points) | prominent, accompanied by a noticeable | |
| | fermented fragrance | |
| | relatively distinct and refined kudzu root aroma is | 16-23 |
| | present, with a moderately noticeable fermented | |
| | scent | |
| | relatively distinct and refined kudzu root aroma is | 8-15 |
| | present, but the fermented fragrance is faint | |
| | kudzu root aroma is not distinct, or the odor is | 0-7 |
| | unpleasant | |
| | refreshing and pleasant with a well-balanced | 24-30 |
| (30 points) | sweet and sour taste | |
| | fairly refreshing and agreeable, with a | 16-23 |
| | moderately balanced sweet and sour profile | |
| | not refreshing; the sweet and sour flavors are | 8-15 |
| | poorly balanced | |
| | contains unpleasant tastes | 0-7 |
| Texture | uniform and smooth texture with moderate | 16-20 |
| (20 points) | viscosity and no stratification | |
| | relatively uniform and fine texture, fairly | 11-15 |
| | moderate viscosity, and no layering | |
| | slightly granular texture with mild stratification | 6-10 |
| | granular texture, excessively viscous or too thin, | 0-5 |
| | with noticeable separation | |

Table 13 presents the sensory evaluation scores of kudzu root ferment prepared using different embodiments.

TABLE 13

| | White sugar | | | |
|---|---|---|---|---|
| Example | (wt %) | pH | Stabilizer (wt %) | Overall score |
| Example64 | 2 | 4.0 | 0.03 | 67 |
| Example65 | 2 | 4.5 | 0.05 | 76 |
| Example66 | 2 | 5.0 | 0.07 | 79 |
| Example67 | 4 | 4.0 | 0.05 | 74 |
| Example68 | 4 | 5.5 | 0.07 | 75 |
| Example69 | 4 | 5.0 | 0.03 | 84 |
| Example70 | 6 | 4.0 | 0.07 | 75 |
| Example71 | 6 | 4.5 | 0.03 | 77 |
| Example72 | 6 | 5.0 | 0.05 | 91 |

As shown in table 13, the kudzu root ferment with optimal flavor quality can be obtained when the pH is 5.0, the sugar addition is 6%, and the stabilizer content is 0.05%.

Alcohol detoxification test.

Healthy male ICR mice were selected and acclimatized for 3 days. According to experimental requirements, they were randomly divided into a model group and different administration groups. After fasting for 12 hours (with free access to water), the administration groups were orally gavaged with the corresponding samples (7.0 mL/kg), while the model group received an equal volume of pure water. After 30 minutes, each group was administered 54° baijiu (12.5 mL/kg) by gavage. The latency to loss of righting reflex (time from alcohol administration to loss of righting reflex) and the recovery time of righting reflex (time from loss to regain of righting reflex) were observed and recorded for each group.

Table 14 presents the results of the alcohol detoxification tests for different products. Among them, the primary fermentation broth and the secondary fermentation broth were produced under the optimal combination of conditions.

TABLE 14

| | latency to loss of | recovery time of |
|---|---|---|
| Group | righting reflex (h) | righting reflex (h) |
| Model group | 0.28 ± 0.22 | 2.67 ± 1.48 |
| Kudzu root juice | 0.35 ± 0.26* | 3.45 ± 1.05 |
| Primary fermentation broth | 0.56 ± 0.24** | 2.30 ± 1.04 |
| Secondary fermentation broth | 0.68 ± 0.26** | 2.25 ± 1.16 |

Compared with the model group, * indicates p<0.05 and ** indicates p<0.01.

As shown in table 14, the secondary fermentation broth demonstrates optimal efficacy in both preventing alcohol intoxication and promoting sobriety.

Compared with conventional single fermentation, the present invention significantly enhances both aldehyde dehydrogenase activity and physicochemical composition of kudzu root ferment through a dual fermentation process (primary+secondary fermentation). The kudzu root ferment prepared by the present invention exhibits superior alcohol-detoxifying efficacy and is enriched with multiple essential amino acids, offering enhanced nutritional value and improved flavor profile. The present invention utilizes a mixed microbial consortium of yellow rice wine yeast and Lactobacillus plantarum Z38 for dual fermentation of kudzu root, producing a novel functional beverage with alcohol-detoxifying properties. The present invention enhances the utilization efficiency of kudzu root and provides a significant reference for its further development and research.

The above detailed embodiments thoroughly illustrate the implementation of the present invention; however, the invention is not limited to the specific details described in these embodiments. Within the scope of the claims and technical concept of the present invention, various simple modifications and alterations may be made to the technical solutions of the invention, all of which shall fall under the protection scope of the present invention.

What is claimed is:

1. A production method for kudzu root ferment, comprising the following steps:
(1) using kudzu root as raw material, sequentially performing crushing, pulping, homogenization, centrifugation, and steaming to obtain kudzu root juice;
(2) adjusting the pH of the kudzu root juice, then adding Lactobacillus plantarum Z38 and yellow rice wine yeast, followed by ultrasonication and primary fermentation to obtain primary fermentation broth;
(3) adding a carbon source to the primary fermentation broth, adjusting pH, then adding Lactobacillus plantarum Z38 and yellow rice wine yeast again, followed by secondary fermentation to obtain secondary fermentation broth;
(4) adding stabilizers and flavoring agents to the secondary fermentation broth, adjusting pH, thereby obtaining the kudzu root ferment.

2. The production method for kudzu root ferment according to claim 1, wherein the primary fermentation in step (2) is conducted for 1-7 days at a temperature maintained between 28-36° C.

3. The production method for kudzu root ferment according to claim 1, wherein the ultrasonication in step (2) is performed for 30-120 minutes at a frequency ranging from 20 kHz to 50 KHz.

4. The production method for kudzu root ferment according to claim 1, wherein the pH of the kudzu root juice in step (2) is adjusted to 4.5-6.5.

5. The production method for kudzu root ferment according to claim 1, wherein the total inoculation amount of Lactobacillus plantarum Z38 and yellow rice wine yeast in step (2) and step (3) is 3% (w/w); the ratio of Lactobacillus plantarum Z38 to yellow rice wine yeast ranges from (1-3):(1-3); and Lactobacillus plantarum Z38 was deposited with the China Center for Type Culture Collection on Oct. 31, 2024 under accession number CCTCC M 20242392.

6. The production method for kudzu root ferment according to claim 1, wherein the carbon source in step (3) is selected from sugar and lemon slices.

7. The production method for kudzu root ferment according to claim 1, wherein the pH in step (3) is adjusted to 4.5-5.5.

8. The production method for kudzu root ferment according to claim 1, wherein the stabilizer in step (4) is selected from the group consisting of xanthan gum, sodium alginate, pectin, and combinations thereof; and the flavoring agent includes, but is not limited to, white sugar.

9. The production method for kudzu root ferment according to claim 1, wherein the pH in step (4) is adjusted to 4.0-5.0.

10. A kudzu root ferment prepared by the production method according to claim 1.
